(19) United States
(12) Patent Application Publication
(10) Pub. No.: US 2026/0074172 A1
(43) Pub. Date: Mar. 12, 2026

(54) MULTI-REFLECTION MASS SPECTROMETER

(71) Applicant: Thermo Fisher Scientific (Bremen) GmbH, Bremen (DE)

(72) Inventors: Dmitry GRINFELD, Bremen (DE); Mikhail SKOBLIN, Bremen (DE)

(73) Assignee: Thermo Fisher Scientific (Bremen) GmbH, Bremen (DE)

(21) Appl. No.: 19/325,405

(22) Filed: Sep. 10, 2025

(30) Foreign Application Priority Data
Sep. 11, 2024 (GB) 2413321.7

(51) Int. Cl. H01J 49/40

(52) U.S. Cl. CPC H01J 49/406; H01J 49/405

(57) ABSTRACT

A multi-reflection mass analyser comprises a pair of opposed ion-optical mirrors elongated linearly along a longitudinal axis that extends centrally through the mass analyser, and either one or both ion-optical mirrors comprises a series of spaced apart electrodes. Each electrode is elongated along the longitudinal axis. The series of electrodes extend in a direction transverse to the longitudinal axis and the electrodes are spaced apart by a series of gaps. The series of electrodes comprises a first pair of adjacent electrodes and a second pair of adjacent electrodes. The first pair of adjacent electrodes are separated by a straight gap defined by respective straight edges of the adjacent electrodes. The second pair of adjacent electrodes are separated by a curved gap defined by respective curved edges of the adjacent electrodes.

### CROSS-REFERENCE TO RELATED APPLICATION

This application claims priority from United Kingdom patent application no. GB 2413321.7, filed Sep. 11, 2024. The entire disclosure of GB 2413321.7 is incorporated herein by reference.

### FIELD

The present disclosure relates to the field of mass spectrometry, in particular high mass resolution time-of-flight mass spectrometry and electrostatic trap mass spectrometry.

### BACKGROUND

FIG. 1A and FIG. 1B are schematic diagrams of a multi-reflection mass spectrometer comprising parallel ion-optical mirrors elongated linearly along a drift length, illustrative of prior art analysers like that described in patent publication no. SU1725289. Each ion-optical mirror comprises a series of electrodes that are each elongated linearly along a drift length and separated by small gaps. Ions are injected from an ion source towards the opposing ion-optical mirrors that are arranged parallel to one another. The ions travel into one mirror, are reflected and so travel back towards the other mirror, whereupon they are reflected once more and so proceed back to the first mirror, and so on. In this way the ions follow a zigzag path through the mass analyser, drifting relatively slowly from the ion source to an ion detector, upon which they impinge and are detected. Although FIG. 1A shows the ion source and ion detector located within the volume bounded by the mirrors, either or both of the source and detector may be located outside the volume.

The ion flight paths vary according to the angle at which a particular ion is injected into the mirror. FIG. 1A shows three different ion paths, and illustrates the spreading in the ion beam as it drifts along the mass analyser where there is no focusing in the drift direction. The provision of lenses in between the mirrors, periodic modulations in the mirror structures themselves, and separate mirrors have been proposed to control this beam divergence along the drift length. However, it is advantageous to allow the ions to spread out as they travel along the drift length so as to reduce space charge interactions, provided they can be brought to some convergence for detection.

FIG. 2 shows another approach to addressing ion beam divergence, described in patent publication U.S. Pat. No. 9,136,102. The mirrors are tilted by an angle θ such that their separation in the drift direction away from the ion source decreases. Ions are injected into the mirrors at an initial inclination angle, and the mirror convergence tilt angle θ causes the trajectory inclination angle of the ions to decrease by 20 upon every oscillation (which includes two reflections). Consequently, the ions' drift direction is eventually reversed such that the ions travel back through the mirror electrodes to be detected by an ion detector positioned adjacent the ion trap. Traversing the mirrors twice extends the flight path of the ions which is desirable as it increases the time-of-flight separation of ions because, in time-of-flight (ToF) mass spectrometers, it increases the ability to distinguish small mass differences between ions.

However, tilting the mirrors causes ToF aberrations. This is because not all ions follow a common path through the mirror electrodes. The finite spread in the beam angle at which the ions are injected into the mirror electrodes results in some ions drifting further down the mirror electrodes than other ions. Advantageously, the ions are spatially focused once more when they return to the ion detector. However, a temporal aberration is introduced because the period of oscillation of the ions decreases as a function of the distance along the drift direction as a result of the decreasing separation between the mirror electrodes.

These ToF aberrations are rectified by decelerating the ions as they cross between the mirror electrodes using stripe electrodes. The stripe electrodes are shaped to create an electric field with a voltage that changes as a function of the distance along the mirrors, thereby mitigating the decrease in period due to the converging mirror electrodes.

FIG. 3 is schematic diagram of a multi-reflection mass spectrometer comprising opposing ion-optical mirrors that have the shapes of parabolas and where the mirrors converge towards each other along the drift direction away from the ion source. Such a spectrometer is described in patent publication U.S. Pat. No. 9,136,102. Ions are again reflected from one mirror to the other mirror multiple times as the ions drift along the mirrors away from the ion source so as to follow a generally zigzag path. The ions' drift is opposed by the electric field resulting from the converging mirrors, and the ions eventually reverse direction and travel back towards the ion source. An ion detector is located in the vicinity of the ion source, and this ion detector intercepts and detects the ions. FIG. 3 shows three ion paths to represent the spread in the ion beam as the ion beam progresses along the mirrors away from the ion source. The spread in the ion beam arises due to the spread in angles in which the ions are injected into the mirrors. FIG. 3 also shows that the ion paths converge as the ions travel back through the mirrors to the ion detector. A parabolic shape of ion mirrors in FIG. 3 is advantageous because the parabolic mirrors converge ion trajectories to a point even for a wide range of ion injection angles, while straight mirrors as in FIG. 2 focus ion trajectories over only a relatively small interval of injection angles.

The parabolic shape of the mirrors sees a parallel incident bunch of ion trajectories gathered into a point after reflection, in analogy with an optical parabolic mirror. As applied to the electrical field of the ion-optical mirrors, the parabolically-curved mirror electrodes provide fully constrained ion motion. The isochronism of ion motion may be achieved with the use of stripe electrodes having parabolic shapes.

As mentioned above, the ion-optical mirrors each comprise a set of elongated electrodes. The mirror electrodes are situated symmetrically on both sides of a plane, in which the ion beam propagates. Some electrodes have accelerating voltages (negative voltages assuming the ions are anions) and other electrodes have decelerating voltages (positive voltages for anions). Electrodes with negative voltages create electrical fields that have an ion-optical focusing effect, while the electrodes with positive voltages create electrical fields that slow down the ions and reflect them back towards the other mirror. The set of negative and positive voltages is optimized to provide the chromatic reflection isochronism, namely independence of the ion travelling time from variations in initial kinetic energy and small displacements around the plane of symmetry.

To achieve the precise electrical fields required for high resolution mass spectrometry, the mirror electrodes must be made to within very tight tolerances. The stringent requirements stem from the fact that adjacent mirror electrodes have voltage differences of several kilovolts and, therefore, even a micron-level error in their shapes induces substantial errors of the resulting electrostatic field distribution. For example, the mechanical tolerance of the mirror electrodes may be a maximum of 10-20 micrometres for the whole length of the mirrors which may be about one metre. This accuracy is far easier to achieve for straight electrodes where fabrication technologies such as precise milling and wire erosion may be used. This level of precision is far harder to achieve for curved surfaces such as are present in the parabolically-shaped electrodes. Hence, while parabolically shaped mirrors theoretically provide excellent resolution, this resolution is difficult and expensive to achieve due to the difficulties in manufacturing the electrodes to the necessary tolerances.

### SUMMARY

The current disclosure introduces an ion-optical mirror, whose ion-optical properties are essentially like that of a mirror comprising parabolic electrodes and a parabolic compensation stripe. At the same time, most of the electrodes of the ion-optical mirror of the current disclosure are straight, and only a few electrodes are curved. Notably, any adjacent electrodes with a high voltage between them have straight surfaces facing each other, which facilitates their precise fabrication. The few curved electrodes have relatively small voltage differences, which greatly mitigates the tolerance requirements.

Notably, the effective curvature and the isochronism of the ion-optical mirrors of the current disclosure are regulated and adjusted by variation of the relatively small voltage differences between the electrodes of curved shapes. This advantage contrasts with the concave ion optical mirror of FIG. 4 with all electrodes being of parabolic shape, and whose focusing strength is determined by fabrication and cannot be modified electrically.

A first aspect of the present disclosure resides in a multi-reflection mass analyser comprising a pair of opposed ion-optical mirrors. The mirrors are elongated along a longitudinal axis that extends centrally through the mass analyser. Either one or both ion-optical mirrors comprises a series of spaced apart electrodes in which:
(i) each electrode is elongated along the longitudinal axis;
(ii) the series of electrodes extend in a direction transverse to the longitudinal axis and the electrodes are spaced apart by a series of gaps;
(iii) the series of electrodes comprises a first pair of adjacent electrodes and a second pair of adjacent electrodes;
(iv) the first pair of adjacent electrodes are separated by a straight gap defined by respective straight edges of the adjacent electrodes; and
(v) the second pair of adjacent electrodes are separated by a curved gap defined by respective curved edges of the adjacent electrodes.

The first pair of electrodes (with the straight gap) may be used to reflect ions in a direction transverse to the longitudinal axis such that the ions oscillate between the mirrors. This requires relatively high potential differences between the adjacent electrodes which in turn places a relatively high tolerance requirement for the straight edges of the adjacent electrodes of the first pair. Also, the second pair of adjacent electrodes (with the curved gap) may be used to deflect ions in a direction in line with the longitudinal axis such that the ions may reverse their drift direction after a number of reflections in the mirrors. A relatively weak electric field and, therefore, a relatively small potential difference is required between the adjacent electrodes of the second pair for this purpose (relative to the relatively large potential difference between the adjacent electrodes of the first pair) which in turn places a forgiving tolerance requirement for the curved edges of the adjacent electrodes of the second pair. Hence, this addresses the difficulties faced in machining curved electrodes to high precision.

For example, the straight edges of the first pair of electrodes may be formed within a tolerance of less than 10 microns and the curved edges of the second pair of electrodes may be formed within a tolerance of more than 10 microns. Also or alternatively, the straight edges of the first pair of electrodes may be formed within a tolerance of at least an order of magnitude less than curved edges of the second pair of electrodes.

The curved edges of the second pair of adjacent electrodes may be defined according to a function corresponding to the logarithm of a quadratic polynomial. The edges of the adjacent electrodes of the first and/or second pair may have corresponding shapes such that the gaps between them have a constant width along the longitudinal axis. The straight edges of the first pair of electrodes are preferably fabricated by metal cutting along a straight line, and the curved edges of the second pair of electrodes are fabricated by metal cutting along a curved line defined by a formula. Optionally, the second pair of electrodes separated by the curved gap are the outermost pairs of electrodes relative to the longitudinal axis.

The multi-reflection mass analyser may further comprise a controller configured to place electrical potentials on the series of electrodes such that the potential difference between the adjacent electrodes of the first pair (having straight edges) is relatively high compared to the potential difference between the adjacent electrodes of the second pair (having curved straight edges). For example, the potential difference between the adjacent electrodes of the first pair (having straight edges) may be at least ten, at least one hundred or at least one thousand times higher than the potential difference between the adjacent electrodes of the second pair (having curved straight edges).

Optionally, the longitudinal axis of the mass analyser defines the y axis of a Cartesian co-ordinate system, and the series of electrodes extend at right angles to the y axis to define the z axis. Then, each mirror may comprise first and second series of corresponding electrodes that oppose each other and are spaced apart in the x axis direction.

The controller may be further configured to provide an accelerating electrical potential for accelerating ions along the mass analyser. The controller may be configured to provide accelerating and/or decelerating electrical potentials on the electrodes of the ion-optical mirrors. The outermost electrodes of the ion-optical mirrors may receive a decelerating electrical potential higher than the accelerating electrical potential so that the decelerating electrical potential stops the ions at some point inside each of the ion-optical mirrors and reflects the ions back out of the ion-optical mirror towards the other ion-optical mirror. Therefore, some of the electrodes with electrical potentials below the accelerating electrical potential are traversed by the ions before and after each reflection (“traversed electrodes”), and others of the electrodes with voltages above the accelerating electrical potential are not reached by the ions (“non-traversed electrodes”), but the electrical potentials in the non-traversed electrodes affect the ion motion near the point of reflection.

Accordingly, the electrodes of the mirror may belong to one of two groups: (1) traversed electrodes and (2) non-traversed electrodes that are positioned beyond the point of reflection.

The controller may be further configured to provide an accelerating or a decelerating electrical potential to a curved one of the traversed electrodes. The curved edge of this traversed electrode may generate an electrostatic field that has a component along the longitudinal axis and deflects the ions in this axis. An edge of a parabolic shape according to the formula

$${s}^{′} ( y ) = {s}_{0}^{′} + {k}^{′} {y}^{2}$$

generates an uneven longitudinal electrostatic field component with a focusing effect like that of a concave (convex) parabolical mirror. The controller being configured to provide a certain electrical potential difference across a pair of adjacent electrodes with parabolically curved edges, it is possible to modify the focusing effect on the ions and, therefore, to modify the effective focal length of the ion-optical mirror. The time-of-flight effect of a traversed, curved electrode consists in the deceleration or acceleration of the ions while traversing this electrode. The time-of-flight effect of a traversed, curved electrode is substantially non-zero, making a mirror with only curved traversed electrodes substantially non-isochronous.

The controller may be further configured to place an electrical potential above the acceleration voltage on a curved one of the non-traversed electrodes, i.e. one of the electrodes positioned beyond the point of reflection of the ions. Nevertheless, the electrical potential placed on a non-traversed, curved electrode affects the ions near their reflection point z_{R} due to a field penetration effect proportional to the exponent

$$exp ( - π \frac{s ( y ) - {z}_{R}}{2 H} )$$

where z_{R} is the z-coordinate of the reflection, s(y)>z_{R} is a z-coordinate of the curved edge, and 2H is the separation in the x-axis between the planes where the electrodes are placed both sides of the middle plane of the ion-optical mirror. As the edge shape s(y) is non-constant along the longitudinal axis, application of an electrical potential difference between a pair of non-traversed, curved electrodes (with a curved gap between them) affects the ion deflection and the reflection time unevenly in the longitudinal axis y.

To generate a deflection and time-of-flight effects on the ion trajectories that depends parabolically (as a quadratic function) of the longitudinal coordinate, the curved edges of non-traversed electrodes may follow a log-parabolical shape (i.e. be defined according to a function corresponding the logarithm of a quadratic polynomial). The log-parabolical shape may be defined by a formula

$$s ( y ) = \frac{2 H}{π} log \frac{H}{{s}_{0} - {ky}^{2}}$$

where s₀ and k are constants.

The time-of-flight effect of a non-traversed electrode comes from a small shift of the point of reflection in the axis z. Application of a more-decelerating electrical potential to a non-traversed electrode makes the ion path in the ion-optical mirror shorter and decreases the time of flight per reflection. Conversely, application of a smaller (less decelerating) electrical potential elongates the ion path and so the reflection takes longer. The time-of-flight effect of a non-traversed electrode is in the opposite proportion to the time-of-flight effect of a traversed electrode. Therefore, a combination of traversed, curved electrodes with parabolic shapes and non-traversed, curved electrodes with log-parabolic shapes may have the time-of-flight effects mutually compensated. An ion-optical mirror with such curved electrodes is isochronous and provides zero time-of-flight aberrations to the ions, which means that the reflection time doesn't depend on the y-coordinate of the reflection point.

Thus, the present disclosure may provide an isochronous ion-optical mirror comprising at least one traversed, curved electrode of a parabolic shape and at least one non-traversed, curved electrode of a log-parabolic shape. The controller may be configured to provide electrical potentials on the curved electrodes with relative magnitudes that compensate the time-of-flight aberration on an extent in the longitudinal direction.

Hence, the series of electrodes may further comprise a third pair of adjacent electrodes. The third pair of adjacent electrodes may be separated by a curved gap defined by respective parabolically shaped edges of the third pair of adjacent electrodes. The third pair of adjacent electrodes may have parabolically shaped edges of a corresponding shape so that the gap separating the third pair of adjacent electrodes has a constant width. Such an arrangement is advantageous as it allows a further contribution to reflecting the ions in a direction in line with the longitudinal axis such that the ions reverse their drift direction through the mirrors.

The controller may be configured to place electrical potentials on the series of electrodes such that the potential difference between the adjacent electrodes of the first pair (with straight edges) is relatively high compared to the potential difference between the adjacent electrodes of the third pair (with parabolically curved edges). For example, the potential difference between the adjacent electrodes of the first pair (straight edges) may be at least ten, at least one hundred or at least one thousand times higher than the potential difference between the adjacent electrodes of the third pair (parabolically curved edges). This difference in the electric field strengths is possible because the reflecting effect of the mirrors in the direction ‘z’ is predominantly achieved by the electric field between straight edges, while the electric field between curved edges is intended to control a relatively slow ion motion in the longitudinal direction ‘y’. The ion's kinetic energy component along the ‘y’ direction is related to the kinetic energy component along the ‘z’ direction as K_{y}/K_{z}=tan² ϑ where ϑ is the ion's incident angle, which is preferably below five degrees. Therefore, the drift energy component is at least 100× smaller than the z-component.

This relatively small potential difference between the adjacent electrodes of the third pair (with parabolically curved edges) allows a relatively low tolerance requirement for their curved edges and so also addresses the difficulties faced in machining curved electrodes to high precision. For example, the straight edges of the adjacent electrodes of the first pair may be formed within a tolerance of less than 10 microns and the parabolically shaped edges of the adjacent electrodes of the third pair may be formed within a tolerance of more than 10 microns. Also or alternatively, the straight edges of the adjacent electrodes of the first pair may be formed within a tolerance to at least an order of magnitude less than the parabolically shaped edges of the adjacent electrodes of the third pair.

The third pair of adjacent electrodes (parabolically curved edges) may be the innermost electrodes relative to the longitudinal axis. The controller may be configured to place electrical potentials on the adjacent electrodes of the third pair (parabolically curved edges) such that the innermost electrode is grounded.

The curved gaps between the second and third pair of adjacent electrodes introduce a time-of-flight variation to ions passing through the ion-optical mirrors. Advantageously, the use of a parabolically shaped gap between the third pair of adjacent electrodes (which may be traversed electrodes) and a log-parabolically shaped gap between the second pair of adjacent electrodes (which may be non-traversed electrodes) means that the variations in time-of-flight act in opposite senses (i.e. one leads to an increase in time of flight and the other leads to a decrease). This allows the second and third pair of adjacent electrodes (traversed and non-traversed electrodes respectively) to be shaped such that the time-of-flight variation introduced by them cancel, at least partially cancel, or substantially cancel each other.

The sets of electrodes are preferably shaped to form gaps of uniform widths between strait and curved electrodes. A gap between two curved electrodes has a curved shape. A gap between traversed curved electrodes is preferably shaped parabolically according to the formula

$${s}^{′} ( y ) = {s}_{0}^{′} + {k}^{′} {y}^{2}$$

and a gap between non-traversed electrodes is shapes according to the log-parabolic formula

$$s ( y ) = \frac{2 H}{π} log \frac{H}{{s}_{0} - k {y}^{2}}$$

Then, the values of s₀, s′₀, k and k′ and the electrical potential differences across the gaps may be set such that the time-of-flight variation introduced to ions by the third pair of adjacent electrodes (traversed) is cancelled or substantially cancelled by the time of flight variation introduced to ions by the second pair of adjacent electrodes (non-traversed).

Optionally, the series of electrodes comprises further pairs of adjacent electrodes that are separated by straight gaps defined by respective straight edges of the adjacent electrodes. The innermost pair of adjacent electrodes may form the third pair of adjacent electrodes (with the parabolically shaped gap between them), the outermost pair of adjacent electrodes may form the second pair of adjacent electrodes (with the log-parabolically shaped gap between them). The series of electrodes may comprise seven electrodes, with electrodes one and two (counting outwardly from the longitudinal axis) forming the third pair (with parabolically shaped gap), electrodes two to six each being separated by straight gaps (such that any adjacent pair correspond to the first pair of electrodes as defined above), and electrodes six and seven forming the second pair (with a log-parabolically shaped gap).

Optionally, the ion-optical mirrors are symmetric about the longitudinal axis. In such arrangements, both ion-optical mirrors act to deflect ions in the direction in line with the longitudinal axis (the drift direction) and eventually reverse the direction of ion drift. Alternatively, only one ion-optical mirror may comprise curved electrodes as described in any of the various configurations above, while the other ion optical mirror may comprise a series of straight-edged electrodes such that each pair of adjacent electrodes are separated by a straight gap. In such arrangements, only one ion-optical mirror acts to deflect ions in the direction in line with the longitudinal axis (the drift direction).

The multi-reflection mass analyser may further comprise an ion source positioned at one end of the ion-optical mirrors and ion optics operable to inject ions generated by the ion source into the ion-optical mirrors. An ion detector may be positioned at the same end of the ion-optical mirrors as the ion source. The ion detector may be operable to detect ions that have been reflected by the ion-optical mirrors.

The present disclosure also resides in a method of operating any of the multi-reflection mass analysers described above, the method comprising the controller placing electrical potentials on the series of electrodes such that the potential difference between the adjacent electrodes of the first pair is relatively high compared to the potential difference between the adjacent electrodes of the second pair.

Where the second pair of adjacent electrodes are the outermost electrodes relative to the longitudinal axis, the method may comprise the controller providing an accelerating electrical potential for accelerating ions through the mass analyser and placing electrical potentials on the adjacent electrodes of the second pair that are higher than the accelerating electrical potential.

Where the series of electrodes further comprises a third pair of adjacent electrodes and the third pair of adjacent electrodes are separated by a curved gap defined by respective parabolically shaped edges of the adjacent electrodes, the method may comprise the controller placing electrical potentials on the series of electrodes such that the potential difference between the adjacent electrodes of the first pair is relatively high compared to the potential difference between the adjacent electrodes of the third pair.

### BRIEF DESCRIPTION OF THE DRAWINGS

FIG. 1A and FIG. 1B show a first prior art mass analyser.

FIG. 2 shows a second prior art mass analyser.

FIG. 3 shows a third prior art mass analyser.

FIG. 4 shows a parabolically shaped ion-optical mirror of a mass analyser.

FIG. 5. shows a quasi-parabolic mirror that may be used in a mass analyser according to the present disclosure.

FIG. 6 shows another quasi-parabolic mirror that may be used in a mass analyser according to the present disclosure, along with the electrical field strength within the mirror.

FIGS. 7A-7D show perturbations of the action integral and time of flight as a function of the position of the gaps between electrodes of the mirrors.

FIG. 8 shows another quasi-parabolic mirror that may be used in a mass analyser according to the present disclosure.

FIG. 9 shows a mass analyser including opposed quasi-parabolic mirrors.

### DETAILED DESCRIPTION

As explained above, FIG. 1A and FIG. 1B are schematic diagrams of a prior art multi-reflection mass analyser comprising parallel ion-optical mirrors elongated linearly along a drift length. FIG. 1A shows the analyser in the y-z plane and FIG. 1B shows the same analyser in the x-z plane. Opposing ion-optical mirrors 11 and 12 are elongated along a drift direction y and are arranged parallel to one another. Ions are injected from ion source 14 with mean angle θ to the z axis and with an angular divergence δθ, in the y-z plane. Three ion flight paths are depicted at 20a, 20b and 20c to illustrate some of the different paths that arise from this angular divergence δθ. The ions 20 follow the zigzag ion flight path, drifting relatively slowly in the drift direction y. After multiple reflections in mirrors 11 and 12, the ions 20 reach the ion detector 16.

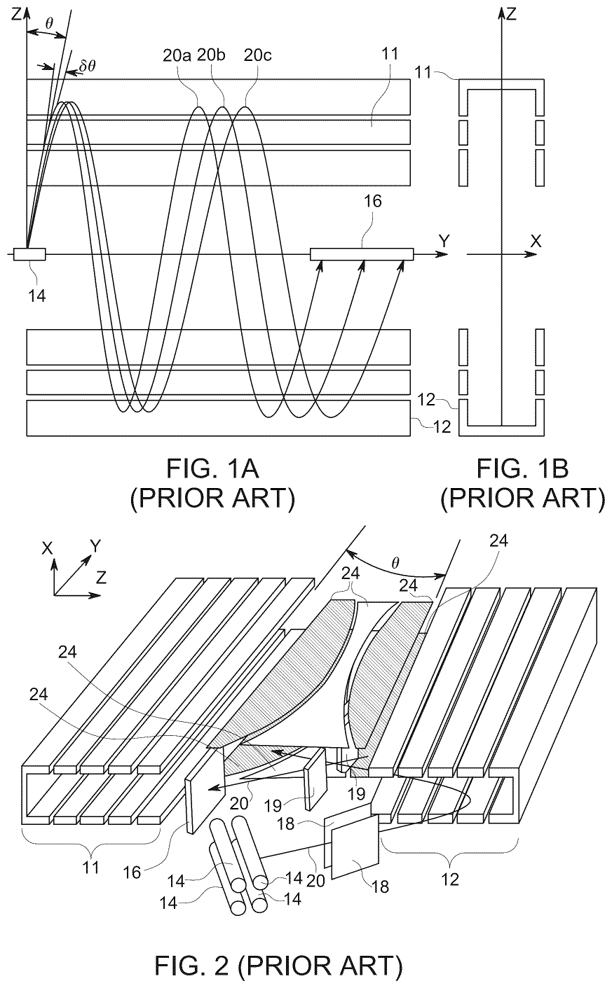

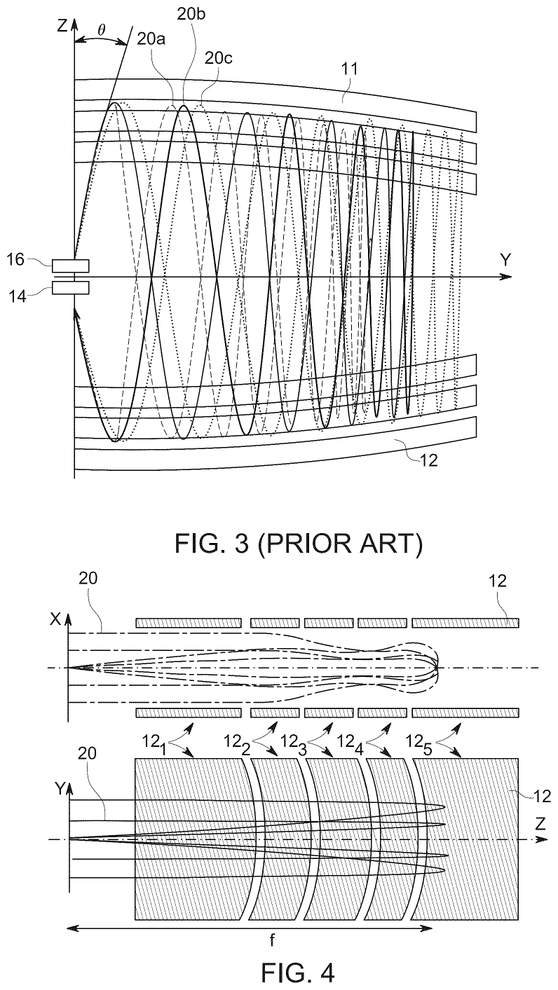

FIG. 2 shows a prior art multi-reflection time-of-flight mass analyser comprising mirrors 11 and 12 tilted by an angle θ such that their separation in the z direction decreases as they extend in the drift direction y. Ions are provided from an ion trap 14 to form an ion beam 20 that is steered and shaped by electrodes 18 and 19. The ions in the ion beam 20 oscillate between the opposing mirrors 11 and 12 in the Y direction. The mirror convergence tilt angle θ causes the ions' drift to reverse such that the ions 20 travel back through the mirrors 11 and 12 to be detected by the ion detector 16. This detector 16 is positioned adjacent the ion trap 14. As explained above, the time-of-flight aberrations introduced by the tilted mirrors 11 and 12 are rectified by decelerating the ions 20 as they cross between the mirror electrodes 11 and 12 using the stripe electrodes 24.

FIG. 3 is a schematic diagram of a multi-reflection mass spectrometer comprising opposing parabolic ion-optical mirrors 11 and 12 that converge towards each other in the drift direction away from the ion source 14. As already described, ions 20 follow zigzag paths through the mirrors 11 and 12 and their drift direction reverses such that the ions 20 travel back towards the detector 16. Compared to the arrangement of FIG. 2, the parabolic ion-optical mirrors in FIG. 3 provide superior spatial focusing of ion trajectories; however, the fabrication of curved electrodes is hindered by stringent tolerance requirements.

FIG. 4 is a schematic diagram of a single parabolic mirror 12 to illustrate its operation. The mirror 12 is defined by five electrodes 12₁-12₅ that are separated by parabolically-shaped gaps. Electrode 12₁ is the innermost electrode closest to the central axis of the mass analyser 10, and electrode 12₅ is the outermost electrode. The other electrodes are labelled sequentially as 12₂-12₄. The mirror's principal ion-optical property consists in providing a certain inclination angle ϑ(y) to each ion 20 upon a reflection, which depends on the incidence point y along the y axis. The mirror 12 has all electrodes 12₁-12₅ curved in accordance with a quadratic function Δ(y)=y²/2R where R is the radius of curvature, the same for all electrodes 12₁-12₅. The action integral on the ion's path from the plane z₀ to the point of flight reverse zₘ(y) and back to the plane z₀ is

$$I ( y , u ) = 2 {\int }_{{z}_{0}}^{{z}_{m} ( y , u )} \sqrt{2 q m ( u - ϕ ( y , z ) )} dz \qquad ( 1 )$$

where m, q, and u are the ion's mass, charge, and the acceleration voltage, respectively. More convenient is the action normalized to the incident ion's momentum p_{z}=√2mqu. This value is described by the mass-independent integral with the dimension on length

$$J ( y , u ) = 2 {\int }_{{z}_{0}}^{{z}_{m} ( y , u )} \sqrt{\frac{u - ϕ ( y , z )}{u}} dz \qquad ( 2 )$$

The action integral given by formula (1) allows deduction of two principal characteristics of the electrostatic mirror 12 as it acts on the reflected ions 20: deflection angle and the time of flight as functions of the incidence point y. A deflected ion 20 acquires a y-component of momentum Δp_{y}=∂I/∂y, therefore the deflection angle is

$$ϑ ( y ) = \frac{Δ {p}_{y}}{{p}_{z}} = \frac{\partial J}{\partial y} \qquad ( 3 )$$

and the time-of-flight difference for a reflection is the action derivative with respect to the ion energy

$$T ( y ) = \frac{1}{q} \frac{\partial I}{\partial u} = \sqrt{2 q m} {\int }_{{z}_{0}}^{{z}_{m} ( y , u )} \frac{d z}{\sqrt{u - ϕ ( y , z )}} \qquad ( 4 )$$

An ideal electrostatic parabolic ion mirror 12 should focus every incident parallel trajectory to a point located at a focal length f, so that the deflection angle is ϑ(y)=−y/f. The action integral for the electrostatic mirror 12 in FIG. 4 calculated for a point y differs from this integral calculated at the middle point y=0 by the two-times free-flight interval of the length Δz=y²/2R. This amount Δz drops out from the integration due to the radius of curvature R. As a result, J(y,u)−J(0,u)=−y²/R and ϑ(y)=−2y/R according to the formula (1), which correspond to the ideal focusing with the focal distance f=R/2.

The time-of-flight properties of the mirror 12 of FIG. 4 are not isochronous: unlike an optical mirror for which the Fermat principle works, the concave electrostatic mirror 12 does not bring ions to the focal point simultaneously: T(y)≠const.

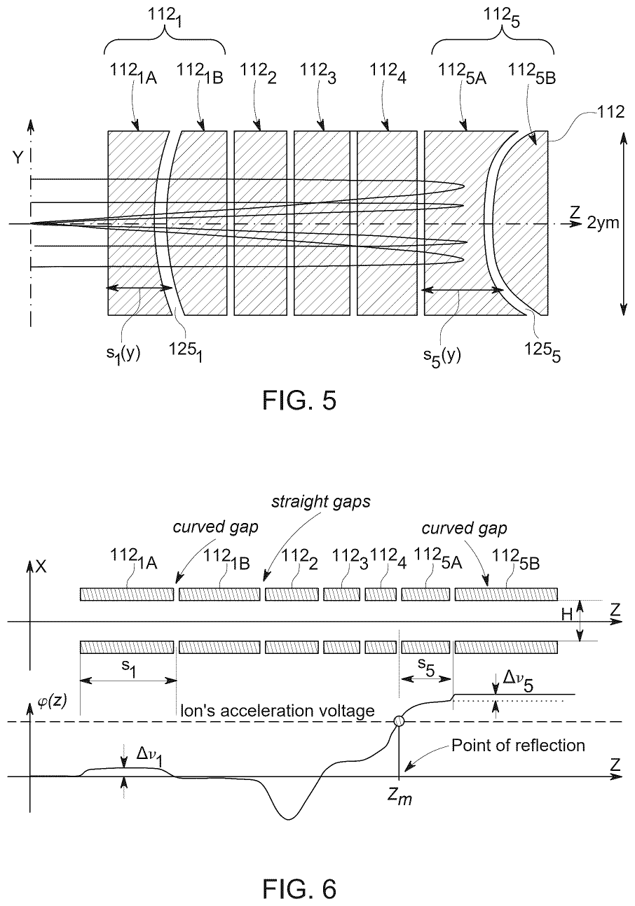

A quasi-parabolic mirror 112 is shown in FIG. 5. It comprises five principal electrodes 112₁-112₅. Generally speaking, the same voltages or similar voltages may be applied to the electrodes 112₁-112₅ as per the corresponding electrodes 12₁-12₅ of the mass analyser of FIG. 4. However, two of the principal electrodes 112₁-112₅ are split into two part-electrodes 112_{1A} & 112_{1B} and 112_{5A} & 112_{5B}. The voltage differences between the principal electrodes 112₁-112₅ are relatively high. Hence, the straight gaps between the principal electrodes 112₁-112₅ are advantageous because known precise methods of machining, like wire erosion, allows manufacturing tolerances of straight edges to be as good as a few microns. The same is not true for electrodes with curved edges, separated by curved gaps, where the same level of manufacturing precision is impossible.

The innermost principal electrode 112₁ is split into electrically isolated part-electrodes 112_{1A} & 112_{1B} that are separated by a curved gap 125₁. The same is true for the outermost principal electrode 112₅ that is split into electrically isolated part-electrodes 112_{5A} & 112_{5B} separated by a curved gap 125₅. Different voltages are applied to the two part-electrodes 112_{1A} & 112_{1B} and 112_{5A} & 112_{5B} of each pair, although the voltages are set such the voltage difference across the gap 125₁ & 125₅ between each pair of part-electrodes 112_{1A} & 112_{1B} and 112_{5A} & 112_{5B} is relatively small. The voltage difference may constitute, for example, only a few percent of the ion acceleration voltage u. This much reduced voltage difference relaxes the precision required when shaping the curved edges of the part-electrodes 112_{1A} & 112_{1B} and 112_{5A} & 112_{5B} that define the curved gaps 125₁ & 125₅, without having a critical effect on the mirror's operation. Generally, the effect of an electrode's mechanical imprecision on the electrostatic field it generates is proportional to the voltage difference between the adjacent electrodes. As the voltage difference across the curved gaps 125₁ & 125₅ is small, for example up to 100 times smaller than the voltage differences across the straight gaps separating the principal electrodes 112₁-112₅, the mechanical tolerances for the curved gaps 125₁ & 125₅ are much more forgiving and may constitute tens of even hundreds of microns. This is compatible with many conventional methods of making curved electrode surfaces, such as milling.

The optimal shapes of curved gaps 125₁ & 125₅ are defined to generate an action integral (2) such that the deflection angle ϑ(y)=−2y/R is a linear function of the coordinate y and the isochronous property T(y)=const is also fulfilled.

The following considerations are used to find these optimal shapes of the curved gaps 125₁ & 125₅ which make a quasi-parabolic ion mirror 112 equivalent to an ideal parabolic ion mirror in terms of the focal distance f=R/2 and a flat dependence of the time-of-flight (i.e. such that ions entering the mirror 112 simultaneously are reflected and arrive at the focal position simultaneously).

In the mirror 112 of FIG. 5, the innermost principal electrode 112₁ is split into two complementary part-electrodes 112_{1A} & 112_{1B}. Generally, one part-electrode is grounded and the other part-electrode receives a small bias. Let, for example, the electrode 112_{1A} be positively biased with a voltage Δv₁ to generate the focusing effect on cations 20. The variation of the shape of the part-electrode 112_{1A} along the y axis can be described as a y-dependent width s₁(y). The bias voltage Δv₁ is small compared with the ion's acceleration voltage u. For example, u may be around 4000 V and |Δv₁|≤40V. The part-electrode 112_{1A} is traversed by the ions 20 twice per oscillation within the mirror 112, once before and once after each reflection, and both traverses cause a perturbation of the action integral. The smallness of the biasing voltage Δv₁ allows a linearized approximation of this perturbation

$$Δ {J}_{1} = 2 {s}_{1} ( y ) ( \sqrt{\frac{u - Δ {v}_{1}}{u}} - 1 ) \approx - \frac{1}{u} {s}_{1} ( y ) Δ {v}_{1}$$

$$Δ {T}_{1} = \frac{1}{q} \frac{\partial }{\partial u} ( \sqrt{2 m q u} Δ {J}_{1} ) \approx \sqrt{\frac{m}{2 q {u}^{3}}} {s}_{1} ( y ) Δ {v}_{1}$$

Note that a positive biassing voltage Δv₁>0 (which decelerates the ions 20 assuming them to be cations) generates a positive time shift ΔT₁, and the time shift is greater for those ions 20 most separated from the axis z in both directions of y. ΔJ₁ and ΔT₁ are proportional to each other and, therefore, spatial focusing of the curved gap 125₁ between the part-electrodes 112_{1A} & 112_{1B} unavoidably generates a time-of-flight variation manifested through a dependence of the time-of-flight on the incidence point y of the ions 20.

However, this variation in time-of-flight may be corrected by splitting another principal electrode 112₂-112₅. In the embodiment shown in FIG. 5, it is the outermost electrode 112₅ that is split into part-electrodes 112_{5A} & 112_{5B}. This principal electrode 112₅ is the electrode with the most positive electrical bias. The variation of the shape of the inner part-electrode 112_{5A} of the pair along the y axis can be described as a y-dependent width s₅(y).

Part-electrode 112_{5A} is biased with a voltage v₅ and part-electrode 112_{5B} is biased with a voltage v_{5B}=v₅+Δv₅, where Δv₅ is small compared with the ion's acceleration voltage u. In conventional mass analysers 10, the voltage v₅ exceeds the acceleration voltage u, and the ions 20 are reflected near the interface between principal electrodes 12₄ and 12₅. In the mirror 112 of FIG. 5, the voltage v₅ set on part-electrode 112₅ also exceeds the acceleration voltage u such that the ions 20 do not completely traverse electrode 112_{5B}. Nevertheless, the difference in voltage applied to the part-electrode 112_{5B} modifies the reflection coordinate of ions zₘ(y) and the action integral on the reflection.

Generally, there is no analytical solution for the action perturbation caused by the voltage Δv₅ applied to the part-electrode 112_{5B}. Nevertheless, the dependence on the width of the part-electrode 112_{5A} s₅(y) is expected to be exponential in accordance with the propagation of a voltage perturbation between two conductive plates separated by a distance H which is determined by an attenuation factor exp(−πs₅/2H). The effects on the action integral and the reflection time are proportional to the voltage bias Δv₅ and the attenuation factor:

$$Δ {J}_{5} = A exp ( - \frac{π {s}_{5} ( y )}{2 H} ) \frac{Δ {v}_{5}}{u}$$

$$Δ {T}_{5} = B exp ( - \frac{π {s}_{5} ( y )}{2 H} ) \frac{Δ {v}_{5}}{u}$$

where A [mm], B [μs] are constants to be determined via numerical simulation. Note that a positive voltage Δv₅ makes the ions 20 (anions) reverse the flight direction at a smaller z-coordinate, so that both the action and the time perturbations are negative. Therefore, the coefficients A and B are both less than zero. Unlike the contributions ΔJ₁ and ΔT₁ arising from the biased part-electrode 112_{1B} which have opposite signs, a bias Δv₅ on the part-electrode 112_{5B} generates the contributions ΔJ₅ and ΔT₅ with the same sign. Therefore, using curved gaps 125₁& 125₅ between part-electrodes 112_{1A} & 112_{1B} and 112_{5A} & 112_{5B} may increase the summed contribution to the action integral ΔJ₁+ΔJ₅ while allowing the subtractive combination to cancel such that ΔT₁+ΔT₅=0. Namely

$$Δ {J}_{1} + Δ {J}_{5} = - \frac{1}{u} {s}_{1} ( y ) Δ {v}_{1} + A exp ( - \frac{π {s}_{5} ( y )}{2 H} ) Δ {v}_{5} = - \frac{{y}^{2}}{2 f} + {c}_{1} \qquad ( 5 )$$

$$Δ {T}_{1} + Δ {T}_{5} = \sqrt{\frac{m}{2 q {u}^{3}}} {s}_{1} ( y ) Δ {v}_{1} + B exp ( - \frac{π {s}_{5} ( y )}{2 H} ) Δ {v}_{5} = {c}_{2} \qquad ( 6 )$$

with a precision to inessential constants because both deflection angle and the time-of-flight difference are expressed through derivatives of (5) and (6). The constant c/drops out when the action perturbation ΔJ is differentiated with respect to y to find a deflection angle ϑ(y); and the constant c₂ is a time-of-flight shift which is the same for all ions and, therefore, is inessential for a time-of-flight mass analyser's operation.

According to equations (5) and (6), the shape functions s₁(y) and s₅(y) of part-electrodes 112_{1B} & 112_{5A} take specific forms

$${s}_{1} ( y ) = {s}_{10} + {k}_{1} {y}^{2} \qquad ( 7 )$$

$${s}_{5} ( y ) = \frac{2 H}{π} log \frac{H}{{s}_{50} - {k}_{5} {y}^{2}} \qquad ( 8 )$$

where s₁₀ [mm], k₁ [mm⁻¹] and s₅₀ [mm], k₅ [mm⁻¹] are coefficients that may be chosen with a certain freedom. Substitution of (7) and (8) into (5) and (6), and equating coefficients before y², gives equations for Δv₁ and Δv₅

$${k}_{1} Δ {v}_{1} + \frac{A {k}_{5}}{H} Δ {v}_{5} = \frac{u}{2 f} \qquad ( 9 )$$

$${k}_{1} Δ {v}_{1} - \sqrt{\frac{2 q u}{m}} \frac{B {k}_{5}}{H} Δ {v}_{5} = 0 \qquad ( 10 )$$

Equation (10) establishes proportionality between Δv₁ and Δv₅ at which the mirror is isochronous with respect to the spread in y positions of the incident ions, and equation (9) sets a desirable focal length.

An advantage of a quasi-parabolic ion mirror 112 is that its effective curvature radius may be varied electrically by applying different biases Δv₁ and Δv₅, which is not possible for a mirror 12 whose electrodes 12₁-12₅ are physically curved. As an example of an implementation of such a quasi-parabolic stripe, we consider an ion-optical mirror 112 with five principal electrodes 112₁-112₅ similar to that shown in FIG. 5.

FIG. 6 shows a side view of such a quasi-periodic electrostatic mirror 112 in which the first and the last principal electrodes 112₁ & 112₅ are each split into two part-electrodes 112_{1A} & 112_{1B} and 112_{5A} & 112_{5B}. Part-electrodes 112_{1B} and 112_{5B} are biased with voltages Δv₁ and Δv₅ with respect to their complementary part-electrodes 112_{1A} and 112_{5A}.

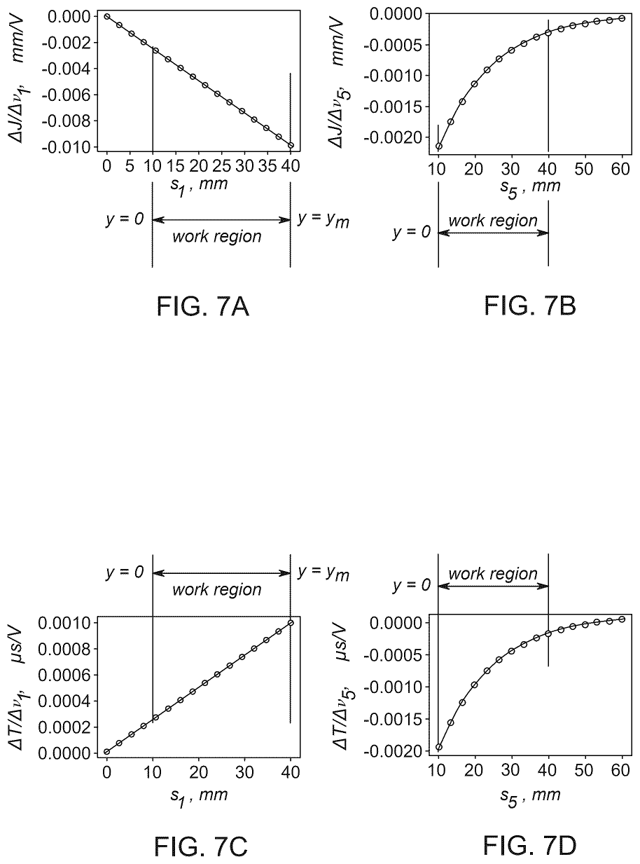

FIGS. 7A-7B illustrate perturbations of the action integral ΔJ normalized to the ion's incidence momentum and the time-of-flight perturbations generated by a Δv₁/u=Δv₅/u=1V/4000V bias of the curved part-electrodes 112_{1B} and 112_{5B}, respectively. FIGS. 7C-7D illustrate corresponding time shifts ΔT for ions with m/z=1000 Da. Both action integrals ΔJ and the time differences ΔT are presented as functions of corresponding gap positions s₁ and s₅, respectively.

As expected from theory, the action integral ΔJ and time perturbations ΔT are linear with s₁ and exponential with s₅, the attenuation constant being π/2H where H=24 mm is the half-distance between the electrodes 111₁-111₅ and 112₁-112₅ along the X axis (these distances are equal as the electrodes 111 and 112 are positioned on the same planes parallel to the plane y-z). It was found from ion-optical simulations (MASIM 3D software package used), that ΔJ≈A exp(−πs₅/2H) and ΔT≈B exp(−πs₅/2H), where the pre-exponent constants A and B were found to be A=−16.676 mm and B=−15.6287 μs (for m/z=1000 Th).

With this information given, the solution for geometry constants in formulas (7) and (8) that achieve a flat dependence of T(y) may be obtained as a simple algebraic exercise. The solution is not unique, one solution with reasonable mechanical constraints reads

$${s}_{10} = {s}_{1} ( 0 ) = 10 mm ,$$

$${k}_{1} = 0.0 \; 03 {mm}^{- 1}$$

$${s}_{50} = 1.75 mm ,$$

$${k}_{5} = 1.72 \times {10}^{- 4} {mm}^{- 1}$$

Solving equations (9) and (10) for Δv₁ and Δv₅ while assuming the focal length of the mirror f=10 m gives Δv₁≈64.2 V; Δv₅≈−61.8V. These voltage differences are small indeed when compared with the ion acceleration voltage u, which justifies the assumptions used to derive the approximate formulas for the action and time-of-flight variations.

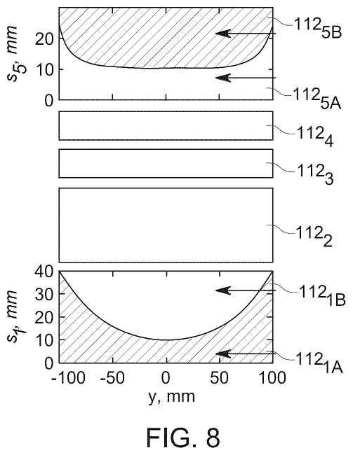

FIG. 8 shows the structure of a quasi-parabolic mirror 112 with gaps between part-electrodes 112_{1A} & 112_{1B} and 112_{5A} & 112_{5B} according to the parameters determined above. The gap s₁(y) separating electrodes 112_{1A} and 112_{1B} is parabolic and the gap s₅(y) between the electrodes 112_{5A} and 112_{5B} is log-parabolic (defined according to a function corresponding to the logarithm of a quadratic polynomial).

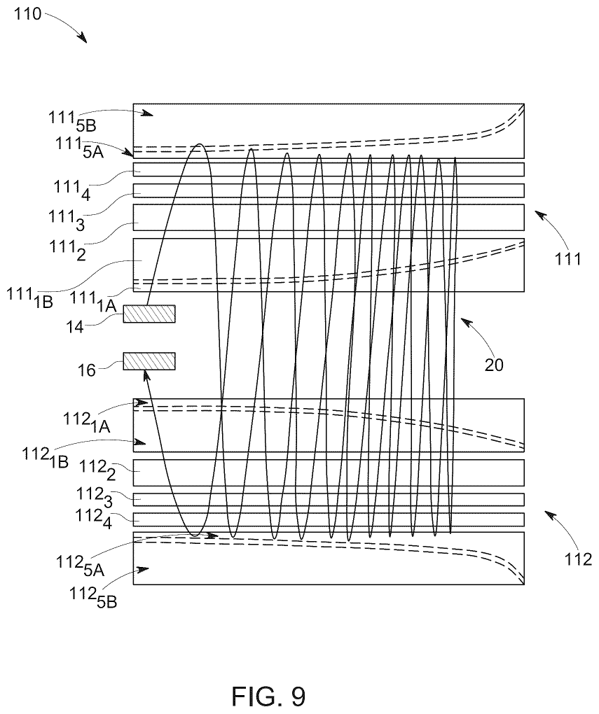

FIG. 9 shows a time-of-flight mass analyser 110 comprising a pair of quasi-parabolic mirrors 111 and 112. Each of the mirrors 111 and 112 comprise part-electrodes 111_{1A} & 111_{1B} and 112_{1A} & 112_{1B} of complementary parabolic shapes according to equation (8), and part-electrodes 111_{5A} & 111_{5B} and 112_{5A} & 112_{5B} of complementary log-parabolic shapes according to equation (8). The other principal electrodes 111₂-111₄ and 112₂-112₄ have straight edges and are parallel to each other, therefore facilitating their high-precision manufacturing.

The ion beam 20 originating from the ion source 14 performs multiple oscillations between the mirrors 111 and 112 before eventually hitting the ion detector 16. In this embodiment, part-electrodes 111_{1B} and 112_{1B} are grounded and the part-electrodes 111_{1A} and 112_{1A} have a voltage bias Δv₁. Part-electrodes 111_{5A} and 112_{5A} have a voltage v₅ above the accelerating voltage u of the ions, which causes the ions 20 to turn back near the interface between electrodes 111₄ & 111_{5A} and 112₄ & 112_{5A}. The part-electrodes 111_{5B} & 112_{5B} are further biased with respect to the part-electrodes 111_{5A} & 112_{5A} by a voltage difference Δv₅, causing the ion reflection point zₘ to vary according to the y direction along the mirrors 111 and 112. The biases Δv₁ and Δv₅ may be set to ensure that the oscillation time of the ions 20 is constant on all oscillations irrespective of their injection angle into the mirrors 111 and 112 or their position along the mirrors 111 and 112 in the drift (y) direction.

In other embodiments, a voltage bias Δv₁ is applied to a stripe electrode 24 of a parabolic shape similar to that shown in FIG. 2. A biased stripe positioned in front of the ion-optical mirrors 111 and 112 may be viewed as a functional part this mirror.

It will be understood by those skilled in the art that the disclosure is not limited to the embodiments shown and that many additions and modification may be made without departing from the scope of the invention as defined in the appending claims.

1. A multi-reflection mass analyser comprising:
a pair of opposed ion-optical mirrors elongated linearly along a longitudinal axis that extends centrally through the multi-reflection mass analyser, wherein either one or both ion-optical mirrors comprises a series of spaced apart electrodes,
wherein:
each electrode is elongated along the longitudinal axis;
the series of electrodes extend in a direction transverse to the longitudinal axis and the electrodes are spaced apart by a series of gaps;
the series of electrodes comprises a first pair of adjacent electrodes and a second pair of adjacent electrodes;
the first pair of adjacent electrodes are separated by a straight gap defined by respective straight edges of the adjacent electrodes; and
the second pair of adjacent electrodes are separated by a curved gap defined by respective curved edges of the adjacent electrodes.

2. The multi-reflection mass analyser of claim 1, wherein the curved edges of the second pair of adjacent electrodes are defined according to a function corresponding to the logarithm of a quadratic polynomial.

3. The multi-reflection mass analyser of claim 2, wherein:
the longitudinal axis of the multi-reflection mass analyser defines a y axis of a Cartesian co-ordinate system, and the series of electrodes extend at right angles to the y axis to define a z axis;
one or both ion-optical mirrors comprise first and second series of corresponding electrodes that oppose each other and are spaced apart in an x axis direction; and
the adjacent electrodes of the second pair have widths s(y) in the z axis direction that vary with position y along the y axis direction according to the log-parabolic formula:
$$s ( y ) = \frac{2 H}{π} log \frac{H}{{s}_{0} - k {y}^{2}}$$
where H is a half-distance between the respective electrode and its corresponding electrode in the x axis direction, so is the minimum width of the respective electrode and k is a constant.

4. The multi-reflection mass analyser of claim 1, wherein one or both of:
(i) the straight edges of the adjacent electrodes of the first pair are formed within a tolerance of less than 10 microns and the curved edges of the adjacent electrodes of the second pair are formed within a tolerance of more than 10 microns; and
(ii) the straight edges of the adjacent electrodes of the first pair are formed within a tolerance of at least an order of magnitude less than the curved edges of the adjacent electrodes of the second pair.

5. The multi-reflection mass analyser of claim 1, further comprising a controller configured to place electrical potentials on the series of electrodes such that a potential difference between the adjacent electrodes of the first pair is at least ten times higher than a potential difference between the adjacent electrodes of the second pair.

6. The multi-reflection mass analyser of claim 5, wherein the second pair of adjacent electrodes are the outermost electrodes relative to the longitudinal axis.

7. The multi-reflection mass analyser of claim 6, wherein the controller is further configured to provide an accelerating electrical potential for accelerating ions through the multi-reflection mass analyser, and the controller is configured to place electrical potentials on the adjacent electrodes of the second pair that are higher than the accelerating electrical potential.

8. The multi-reflection mass analyser of claim 5, wherein the series of electrodes further comprises a third pair of adjacent electrodes and the third pair of adjacent electrodes are separated by a curved gap defined by respective curved edges of the adjacent electrodes of the third pair.

9. The multi-reflection mass analyser of claim 8, wherein the curved edges of the third pair of adjacent electrodes are of a parabolic shape defined according to a quadratic polynomial of a y coordinate.

10. The multi-reflection mass analyser of claim 8, wherein the series of electrodes comprises further pairs of adjacent electrodes that are separated by a straight gap defined by respective straight edges of the adjacent electrodes.

11. The multi-reflection mass analyser of claim 10, wherein the innermost pair of adjacent electrodes form the third pair, the outermost pair of adjacent electrodes form the second pair and all other pairs of adjacent electrodes correspond to the first pair or one of the further pairs of adjacent electrodes.

12. The multi-reflection mass analyser of claim 8, wherein:
the second and third pair of adjacent electrodes are shaped such that a time-of-flight variation introduced to ions by the third pair of adjacent electrodes is cancelled or at least partially cancelled by a time-of-flight variation introduced to ions by the second pair of adjacent electrodes.

13. The multi-reflection mass analyser of claim 8, wherein the controller is configured to place electrical potentials on the series of electrodes such that a potential difference between the adjacent electrodes of the first pair is at least ten times higher than a potential difference between the adjacent electrodes of the third pair.

14. The multi-reflection mass analyser of claim 13, wherein the third pair of adjacent electrodes are the innermost electrodes relative to the longitudinal axis.

15. The multi-reflection mass analyser of claim 14, wherein the controller is configured to place electrical potentials on the adjacent electrodes of the third pair such that one of the electrodes in the third pair is grounded.

16. The multi-reflection mass analyser of claim 8, wherein one or both of:
(i) the straight edges of the adjacent electrodes of the first pair are formed within a tolerance of less than 10 microns and the curved edges of the adjacent electrodes of the third pair are formed within a tolerance of more than 10 microns; and
(ii) the straight edges of the adjacent electrodes of the first pair are formed within a tolerance of at least an order of magnitude less than the curved edges of the adjacent electrodes of the third pair.

17. The multi-reflection mass analyser of claim 8, wherein:
the longitudinal axis of the multi-reflection mass analyser defines a y axis of a Cartesian co-ordinate system, and the series of electrodes extend at right angles to the y axis to define a z axis;
one or both of the ion-optical mirrors comprise first and second series of corresponding electrodes that oppose each other and are spaced apart in an x axis direction;
the adjacent electrodes of the second pair have widths in the z axis direction that vary with position y along the y axis direction according to the formula:
$$s ( y ) = \frac{2 H}{π} log \frac{H}{{s}_{0} - k {y}^{2}}$$
where H is the separation of the respective electrode and its corresponding electrode in the x axis direction, s₀ is the minimum width of the respective electrode and k is a constant; and
the electrodes of the third pair have widths in the z axis direction that vary with position y along the y axis direction according to the formula:
$${s}^{′} ( y ) = {s}_{0}^{′} + {k}^{′} {y}^{2}$$
where s′₀ is the minimum width of the electrode and k′ is a constant.

18. The multi-reflection mass analyser of claim 17, wherein the values of s₀, s′₀, k and k′ are set such that a time-of-flight variation introduced to ions by the third pair of adjacent electrodes is cancelled or at least partially cancelled by a time-of-flight variation introduced to ions by the second pair of adjacent electrodes.

19. The multi-reflection mass analyser of claim 1, wherein the ion-optical mirrors are symmetric about the longitudinal axis.

20. The multi-reflection mass analyser of claim 1, further comprising:
an ion source positioned at one end of the ion-optical mirrors;
ion optics operable to inject ions generated by the ion source into the ion-optical mirrors; and
an ion detector positioned at the same end of the ion-optical mirrors as the ion source and operable to detect ions that have been reflected by the ion-optical mirrors.

21. A method of operating a multi-reflection mass analyser, the method comprising:
with a controller, placing electrical potentials on a series of electrodes such that a potential difference between adjacent electrodes of a first pair of adjacent electrodes of the series of electrodes is at least ten times higher than a potential difference between adjacent electrodes of a second pair of adjacent electrodes of the series of electrodes,
wherein the multi-reflection mass analyser comprises:
a pair of opposed ion-optical mirrors elongated linearly along a longitudinal axis that extends centrally through the multi-reflection mass analyser, wherein either one or both ion-optical mirrors comprises the series of spaced apart electrodes,
wherein:
each electrode is elongated along the longitudinal axis;
the series of electrodes extend in a direction transverse to the longitudinal axis and the electrodes are spaced apart by a series of gaps;
the first pair of adjacent electrodes are separated by a straight gap defined by respective straight edges of the adjacent electrodes; and
the second pair of adjacent electrodes are separated by a curved gap defined by respective curved edges of the adjacent electrodes.

22. The method of claim 21, wherein the second pair of adjacent electrodes are the outermost electrodes relative to the longitudinal axis, and wherein the method comprises, with the controller, providing an accelerating electrical potential for accelerating ions through the multi-reflection mass analyser and placing electrical potentials on the adjacent electrodes of the second pair that are higher than the accelerating electrical potential.

23. The method of claim 21, wherein the series of electrodes further comprises a third pair of adjacent electrodes and the third pair of adjacent electrodes are separated by a curved gap defined by respective parabolically shaped edges of the adjacent electrodes, and wherein the method comprises, with the controller, placing electrical potentials on the series of electrodes such that a potential difference between the adjacent electrodes of the first pair is at least ten times higher than a potential difference between the adjacent electrodes of the third pair.
